(19) United States
(12) Patent Application Publication
(10) Pub. No.: US 2010/0255202 A1
(43) Pub. Date: Oct. 7, 2010

(54) Method and Device for Coating Metallic Pipes or Other Long Components Which Have a Restricted Cross Section

(75) Inventor: Klaus Kreilos, Bochum (DE)

Correspondence Address: THE WEBB LAW FIRM, P.C., 700 KOPPERS BUILDING, 436 SEVENTH AVENUE, PITTSBURGH, PA, 15219, US

(73) Assignee: BABCOCK BORSIG SERVICE GMBH, Oberhausen (DE)

(21) Appl. No.: 12/499,393

(22) Filed: Jul. 8, 2009

(30) Foreign Application Priority Data
Apr. 2, 2009 (DE) 10 2009 015 533.3

(51) Int. Cl. B05D 3/02; B05C 11/00

(52) U.S. Cl. 427/314; 118/68; 118/44

(57) ABSTRACT

In order to mechanically coat relatively long components under temporally and economically optimum conditions, in particular to coat the components continuously, the method is characterised by the following steps: supplying the pipe to be coated into a first processing line in which the pipe is transported axially, preheating the pipe or a portion of the pipe, applying a primer coat, heating the pipe to achieve a polarisation between primer coating and pipe, drying the pipe to completely expel all soluble constituents, feeding the pipe into a second processing line in which the pipe is transported axially, preheating the pipe, applying the coating in a cross-head extruder, heating the pipe in an induction furnace, curing the coated pipe, and cooling the coated pipe.

### BACKGROUND OF THE INVENTION

1. Field of the Invention

The invention relates to a method for coating metallic pipes or other long components which have a restricted cross section, in particular pipes for heat exchangers, and to a device for carrying out this method.

2. Background Information

The utility industry requires large heat exchangers which are installed in the flue gas ducts. The flue gas leaves the boiler and the downstream air preheater, abbreviated to APH, at a temperature of approximately 130 to 170° C. This temperature depends on the type of fuel and in any case is much higher than the acid dew point of the flue gas. If the flue gases in the APH were cooled to a temperature below the acid dew point, the APH and the downstream components would be destroyed by the acid corrosion. For this reason, the flue gas temperature at the coldest point of the APH must be safely above the acid dew point.

However, in the flue gas desulphurisation plant, abbreviated to FDP, which is connected downstream of the APH, depending on the operational method of the FDP only flue gas temperatures below 100 and 110° C. are required. This difference in temperature between the APH and the FDP of >30 K can be used to increase the efficiency of the power station and thus to decrease the CO₂ discharge or to reheat the flue gases downstream of the FDP. However, in order to use this energy, acid-resistant heat exchangers are required which are connected into the stream of flue gas and are able to dissipate the heat by means of a heat carrier medium.

It is also already known to construct the previously described acid-resistant heat exchangers either from fluoroplastics, for example “PFA”, “MFA” or “TFM” or from high-quality chromium nickel material, for example “A59”. From time to time, enamelled pipes have also been used which, however, have not proved very successful and can only be used under quite specific conditions.

A further possibility is to use so-called “lined pipes”. In this method, a “PFA” layer, the so-called “liner” is applied without a fixed bond to a pipe, in particular a steel pipe and thus serves to protect against corrosion. All other materials have been ineffective and have had to be rejected.

The advantages and disadvantages of the known materials which are used will be briefly described in the following:

### PFA (Perfluoropropyl Vinylether)

PFA is absolutely resistant to acid. Even after many years of operation, it is impossible to detect any acid corrosion. There are, however, certain disadvantages. On the one hand, the material is very expensive, so attempts must be made to keep the wall thickness of the tubes (pipes are also included here) as thin as possible. In addition, the material has poor thermal conductivity, which also makes it obligatory to use thin walls. On the other hand, it has a very low strength compared to steel, which markedly decreases even further under relatively high temperatures and thus entails the use of either thick wall thicknesses or small tube diameters. Thick walls together with poor conductivities lead to high costs and small diameters of the tubes also result in narrow channels for the passage of flue gas, which in turn can result in soiling of the heat exchangers. In the turbulent regions of the flue gas, the tubes can impact against one another, thereby possibly resulting in mechanical damage.

Modified PTFE (polytetrafluoroethylene)

Modified PTFE materials have similar characteristics to PFA in respect of acid resistance, but unlike PFA, do not have a melting point. For this reason, they cannot be processed by melt extrusion but can only be extruded as a paste. This means that the material is not melted (as in the case of PFA), but merely compressed in a paste-like form, which is tantamount to a sintering operation. Moreover, since the molecules are only aligned lengthwise to the extrusion direction, a relatively high strength is produced in the longitudinal direction, but in the transverse direction the fatigue strength is relatively low. The material also exhibits a high cold flow characteristic. This means that in the course of time, the material flows away under pressure. Unfortunately, this process cannot be stopped, so that leaks constantly occur at the sealing points of the tubes in the bottom of the pipes. Otherwise, the same problems apply here as for PFA.

### Chromium-Nickel Material

Chromium-nickel material “A59” is virtually resistant to acid. However, its surface which is smooth following production changes even after a short operating time. The surface becomes rough and thus very susceptible to soiling, which can result in the flue gases becoming blocked. However, as “A59” has a high strength, pipes which have a relatively large diameter can be used, which in turn counteracts to some extent the accumulation of dirt. The biggest disadvantage of “A59” is, however, the high price. In the case of “A59”, the costs for an identically rated heat exchanger are approximately double those of PFA.

### Enamelled Pipes

For the most part, enamelled pipes have not been successful in practice. Hydrogen forms between the steel pipe and enamel layer and causes the enamel layer to split and thus results in the destruction of the pipes. The reason for the formation of hydrogen has still not been clearly explained. Appropriate investigations are presently being carried out by enamel manufacturers. However, a conclusion has not yet been reached.

Pipes with a Liner

“Lined pipes” have the advantage that they use a steel pipe as the pressure body. Consequently, the PFA layer merely serves to protect against corrosion and can thus be drawn onto the pressure pipe in a low wall thickness. This results in a considerable reduction in costs. However, a disadvantage is that due to the drop in partial pressure, the acid diffuses through the “lining” and produces corrosion products between the pressure pipe and “liner”. As a result of this, the “liner” splits which in turn leads to the destruction of the pipe by acid. Furthermore, the “liner” is very sensitive mechanically. When the pipes are struck, whether intentionally during cleaning or unintentionally during other repair work, the “liner” often suffers accidental damage in the form of very small holes which goes unnoticed and soon leads to corrosive damage during subsequent operation.

The coating of mechanical components with organic fluoropolymers is known in all kinds of configurations. This is carried out whenever non-stick coatings are required which have also become known under the trade mark name of Teflon® or when it is a matter of protecting the components against external influences. Corresponding linings or coatings exist, for example in many sectors of chemical plant engineering. Generally speaking, a coating is required when there is a risk of the metallic components being damaged by corrosion and thus of the associated installations being adversely affected in terms of their service life. Thus, for example pump impellers or agitator components have been coated with organic fluoropolymers for years.

The known procedural method for coating relatively large components is as follows:

First of all, the workpiece is degreased and sandblasted and then a primer coating of the so-called adherence primer is applied. The fluoroplastics are then applied to this adherence primer. For this purpose, the individual workpieces are transported into a furnace at a predetermined temperature and left there for a specific time until they have reached their coating temperature. They are then removed from the furnace and coated with adherence primer. Subsequently, they are returned into the furnace for a predetermined time for the adherence primer coat to bond with the metallic component (so-called polarisation). They are then removed again from the furnace and coated with the first fluoroplastics layer. This process is repeated several times, as in the conventional method a layer thickness of only approximately 500 μm can be applied in each coating procedure and the workpiece has to be passed into and out of the furnace approximately five times. Moreover, the known method is subject to restrictions in respect of the size of the workpieces, since the workpieces must not be larger than the furnace. The largest furnace used for this purpose is approximately 11 m long. This means that only relatively short components can be coated using the known coating method.

### SUMMARY OF THE INVENTION

The object of the invention is to configure and develop the method mentioned at the outset and previously described in detail, and a corresponding device for coating metallic components such that it is also possible to mechanically coat relatively long components under temporally and economically optimum conditions. In particular, it will be possible to coat the components continuously.

The solution to this problem resides firstly in a method for coating metallic pipes or other long components which have a restricted cross section with acid-resistant anti-corrosion layers, which method is characterised by the following steps:
supplying the pipe to be coated into a first processing line in which the pipe is transported axially,
preheating the pipe or a portion of the pipe,
applying a primer coat,
heating the pipe to achieve a polarisation between primer coat and pipe,
drying the pipe to completely expel all soluble constituents
feeding the pipe into a second processing line in which the pipe is transported axially,
preheating the pipe,
applying the coating in a cross-head extruder,
heating the pipe in an induction furnace,
curing the coated pipe, and
cooling the coated pipe.

A corresponding device for carrying out the method achieves the object according to the invention by a first processing line with a first drive, a first preheating means, a means for applying the primer coat and at least one furnace for curing and drying the workpieces as well as a second processing line with a second drive, a second preheating means, a cross-head extruder for applying the coating, an induction furnace and a curing furnace.

In the following, when a “pipe” is mentioned, this will include all possible components to be coated, the length of which exceeds the expansion and the cross section by a multiple. Since the workpiece is coated from the outside, the pipes or other hollow components can also be sealed unilaterally.

According to a further teaching of the invention, it is possible for the first and second processing lines to be operated separately from one another. Alternatively, it is also possible to operate them together in tandem. The separate configuration is, however, generally preferred, as otherwise the length of the processing lines becomes relatively long and it is possible by the separation to carry out the coating with adherence primer and the later actual fluoroplastics coating at different times and in different locations. In particular, where there are separate lines, the standstill of one line does not immediately entail the standstill of the entire plant.

A further embodiment of the invention provides that the pipes to be coated are connected by suitable pipe connection elements upstream of each processing line and the treatment process is continuous. Thus in this manner, it is effectively possible to coat “continuous” components, which is particularly useful from an economic point of view.

According to further teachings of the invention, the components to be treated are to be degreased and/or sandblasted before being fed into the first processing line, to ensure a reliable bond between primer coat and component. In this context, the term “sandblasting” is understood as also including blasting with corundum bodies, glass bodies or the like.

According to a further preferred embodiment of the invention, the pipe is not only transported axially in the first processing line, but is simultaneously rotated about its longitudinal axis, such that its surface undergoes as it were a helical movement. In this way, it is possible for the primer coat to be applied by spraying, in which case the spraying region can be relatively short in the axial direction when the speed of rotation is coordinated appropriately with the feed speed. The adherence primer is thus applied “spirally” as it were to the component to be coated.

A further embodiment of the invention provides that the component is preheated in the first processing line by means of hot air. When the primer coat is applied, a preheated pipe allows an improved contact between adherence primer and pipe, which is essential for a uniform coating.

A further teaching of the invention provides that the component is preheated by means of hot air in the second processing line as well. Here, preheating is particularly important, as the fluoroplastics applied in a fluid state in the extruder would otherwise prematurely crosslink on the cold metal surface of the component and, in an extreme case, the fluoroplastics could even drip off after the workpiece leaves the extruder cross head. Of course, the component can also be preheated by other suitable measures.

Another preferred embodiment of the invention provides that the application of the primer coat and also the coating in the extruder both take place in a single work step. This is particularly important for an economic, continuous production operation. In this respect, particular attention must be paid to the application and drying processes so that the layer thickness is uniform on the component to be coated. Thus, when the primer coating is applied to a pipe, no “seams” for example should appear due to excessively thick or excessively thin “coating boundary lines”.

According to a further teaching of the invention, the coated component is cured in a furnace. This ensures that a uniform curing of the fluoroplastics layer is possible.

Pipes, in particular steel pipes are preferred as components. The organic fluoropolymers PFA (perfluoropropyl vinyl ether) or MFA (perfluoromethyl vinylether) are preferably used for the coating.

According to a further embodiment of the invention, in a corresponding device for coating pipes, the first drive of the first processing line is provided with a rotary feed means. This rotary feed means can be controlled such that axial and rotatory movements can be influenced individually to allow an optimum adaptation to the width of the application zone of the adherence primer. For applying the primer coat, a spray nozzle is preferably used which, in an advantageous embodiment of the invention, is configured as a wide jet nozzle which extends substantially parallel to the longitudinal axis of the pipe.

### BRIEF DESCRIPTION OF THE DRAWINGS

The invention will be described in detail with reference to drawings illustrating merely one preferred embodiment.

In the drawings:

FIG. 1 schematically shows the components of a first processing line according to the invention, and

FIG. 2 schematically shows the components of a second processing line according to the invention.

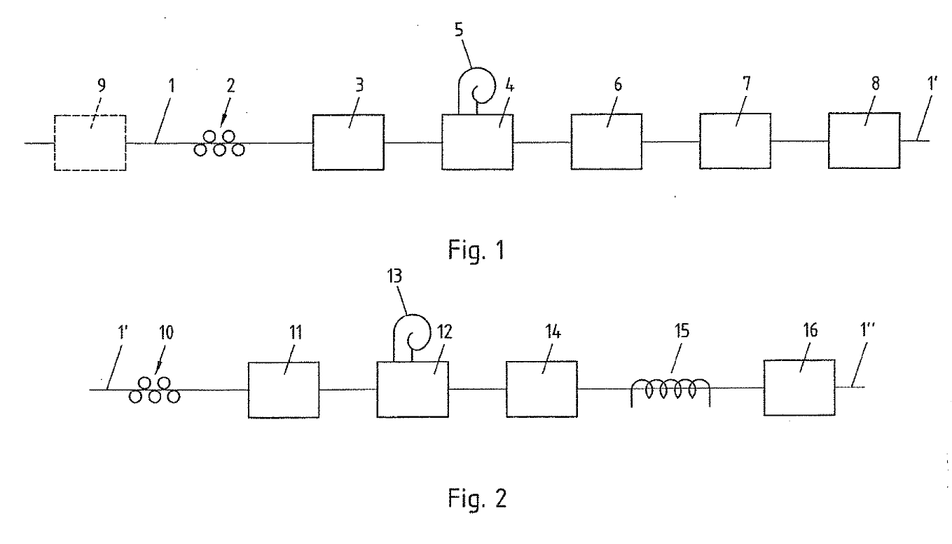

### DETAILED DESCRIPTION OF THE PREFERRED EMBODIMENT

A type of “on line” method was developed for the coating operation. A pipe 1 of any length and preferably made of steel is positioned on a roller conveyor 2 and is advanced in a rotating manner by a specific rotary feed 3. A continuous pipe 1 is produced in that connection elements attach one pipe to the next to achieve a continuous process. In this respect, the rotation of the pipe 1 is in a specific ratio to the feed. This ratio is a function of the diameter.

Connected downstream of the rotary feed 3 is a pipe preheater 4 to preheat the pipe to a primer-specific temperature, preferably by means of a hot air fan 5.

A developed spray device 6 is installed downstream of the preheater. With the cooperation of the pipe preheater 4 and spray device 6, it is possible to apply a uniform primer coat in the predetermined layer thickness onto the rotating pipe 1 in a single work step.

The pipe 1 is then transported by the rotary feed 3 through a drying furnace 7, the length of which is calculated such that, in conjunction with the feed, it ensures the predetermined residence time in the drying furnace 7. This residence time must be observed without fail in order to allow the polarisation, i.e. the bond between the primer and the steel pipe 1, to be completed. In addition, during this time, the volatile constituents must be completely expelled from the primer to prevent later bubble formation in the PFA coating. It must be ensured that the drying procedure takes place uniformly over the layer thickness. If, for example, the outer layer is dried first of all, micro tears will appear in the layer because the residual moisture can no longer escape from the inner layers and thus tears the outer layer which has already dried.

Connected to the drying furnace 7 is a polarisation furnace 8 where the polarisation, i.e. the bond between the adherence primer and the steel pipe 1 takes place. The drying and polarisation temperatures in the furnaces 7 and 8 must be selected and ensured such that although the polarisation temperature is reached and maintained over the full length of the furnace, the polymerisation temperature by which the later bond between primer and PFA or MFA takes place, is not reached. After passing through the drying and polarisation furnaces 7 and 8, the primer coating is completed. Downstream of the furnaces 7 and 8, the pipe 1′ which has been provided with the adherence primer can be removed and, if necessary, divided up. It is obvious that the furnaces 7 and 8 shown individually in the illustrated and, in this respect, preferred embodiment, can also be realised as a combined constructional unit.

Installed next to the coating line for the primer is a similar line for the second coating with PFA or MFA. In this line, the pipe 1′ previously coated with primer is again positioned on a roller conveyor 10 and is advanced at a constant speed by a draw-off means 11. According to the invention, the individual fluoropolymer layers are not applied one after the other as usual, but are melted on in a single procedure by means of an extruder 14 with a cross head (not shown). In order not to move the cold pipe 1′ into the hot (by several degrees) cross head, the pipe 1′ is preheated by a specific mechanism 12, and in so doing, great care must be taken that the polymerisation temperature is not reached.

The molten PFA or MFA is then melted onto the pipe 1′ in a single work step in a full layer thickness by means of the extruder 14. Only after applying the melt is the pipe 1′ heated to a temperature well above the polymerisation point in an induction furnace 15 by induction heat. This consolidates the primer-PFA (or MFA) bond. In a downstream furnace 16, this temperature is maintained until polymerisation has concluded. Here as well, as in the case of the primer coat, the furnace length is linked to the pipe feed. After leaving the furnace 16, the now ready coated pipe 1″ is cooled and transported by a roller conveyor (not shown) for further use. As for the primer line, the individual pipes are connected together in this line as well by connectors, such that a continuous pipe 1′ is produced and can be coated without interruption.

As a result of this coating method according to the invention, it is possible to produce an acid-resistant pipe 1″ of any length. The acid resistance is provided by the applied PFA (or MFA) layer and also by the acid-resistant primer. The strong, undetachable bond between pipe, primer and PFA/MFA means that the layers cannot be undermined and detached by corrosion products. The pressure-resistant carrier pipe controls temperatures and pressures of any magnitude. The diameters of the pipes can also be selected as required by the overall method of the respective power station. Finally, it is also possible to bend the pipes which are coated by the method according to the invention. Thus, for example coated U-tubes can be produced, as used in heat exchangers.

1. A method for coating metallic pipes or other long components which have a restricted cross section, in particular pipes for heat exchangers, with an acid-resistant anti-corrosion layer, comprising the following steps:
supplying the pipe to be coated into a first processing line in which the pipe is transported axially;
preheating at least a portion of the pipe;
applying a primer coat;
heating the pipe to achieve a polarisation between primer coating and pipe;
drying the pipe to completely expel all soluble constituents;
feeding the pipe into a second processing line in which the pipe is transported axially;
preheating the pipe;
applying the coating in a cross-head extruder;
heating the pipe in an induction furnace;
curing the coated pipe; and
cooling the coated pipe.

2. The method according to claim 1, wherein the first and second processing lines are operated separately from one another.

3. The method according to claim 1, wherein the first and second processing lines are operated together.

4. The method according to claim 1, wherein the pipes to be coated are joined by suitable pipe connection elements upstream of each processing line and the treatment process takes place continuously.

5. The method according to claim 1, wherein the pipes to be coated are degreased upstream of the first processing line.

6. The method according to claim 1, wherein the pipes to be coated are sandblasted upstream of the first processing line.

7. The method according to claim 1, wherein the pipe is transported in an axial and rotating manner in the first processing line.

8. The method according to claim 7, wherein the primer coat is applied by spraying.

9. The method according to claim 1, wherein the pipe is preheated by hot air in the first processing line.

10. The method according to claim 1, wherein the pipe is preheated by hot air in the second processing line.

11. The method according to claim 1, wherein the application of the primer coat and/or the coating operation in the extruder takes place in a single work step.

12. The method according to claim 1, wherein the coated pipe is cured in a furnace.

13. The method according to claim 1, wherein steel pipes are used as pipes.

14. The method according to claim 1, wherein (perfluoropropyl vinyl ether) PFA or (perfluoromethyl vinyl ether) MFA organic fluoropolymer is used for the coating.

15. A device for carrying out the method according to claim 1, comprising a first processing line with a first drive, a first preheater, a means for applying the primer coat; at least one furnace for curing and drying; a second processing line with a second drive, a second preheater, a cross head extruder for applying the coating, an induction furnace and a second curing furnace.

16. The device according to claim 15, wherein the first drive is a rotary feed means.

17. The device according to claim 15, wherein the first preheater comprises a hot air fan.

18. The device according to claim 15, wherein the second preheater comprises a hot air fan.

19. The device according to claim 15, wherein a spray nozzle is used as the means for applying the primer coat.

20. The device according to claim 19, wherein the spray nozzle is configured as a wide jet nozzle.

21. The device according to claim 15, wherein a degreasing and/or sandblasting means is connected upstream of the first processing line.

22. The device according to claim 15, wherein both processing lines are connected together to form one complete line.
